(19) United States
(12) Patent Application Publication
(10) Pub. No.: US 2006/0268362 A1
(43) Pub. Date: Nov. 30, 2006

(54) Methods and apparatuses for executing custom scan jobs

(75) Inventors: Amanda Kay Bridges, Winchester, KY (US); William James Gardner Flowers, Lexington, KY (US); Charles Edward Grieshaber, Versailles, KY (US); Chad E. McQuillen, Lexington, KY (US); Michael Ray Timperman, Versailles, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/138,161

(22) Filed: May 26, 2005

(51) Int. Cl. H04N 1/387

(52) U.S. Cl. 358/450; 358/474; 358/540

(57) ABSTRACT

A method of executing a scan job includes scanning a first document, in response to a first user request, to generate a first portion of a scan job, and scanning a second document, in response to a second user request, to generate a second portion of the scan job. The method further includes automatically forming an output document corresponding to the scan job, where the output document includes a combination of the first portion and second portion.

### FIELD OF THE INVENTION

The present invention relates generally to scanning devices, and more particularly, to methods and apparatuses that allow a user to switch between scan sources and alter scan settings within a scan job.

### BACKGROUND OF THE INVENTION

Optical scanning devices, or devices which include optical scanning components, are widely used by businesses and personal users for scanning and transmitting documents and other information. Such scanning devices may electronically scan a document. The output or processed output of the scanning device may be provided as an electronic version of the document that can be further processed or manipulated. For example, the electronic version of the scanned document may be printed, exported or sent to a network, computer or other device, sent via a facsimile transmission, etc. However, conventional scanning devices are limited in that they do not permit the generation of a scan using multiple documents independently placed on an automatic document feeder (ADF) or flatbed. Conventional scanner also do not permit the changing of scan settings during the middle of a scan job.

For example, using conventional scanners, users may place only a single document to be scanned on an ADF or flatbed. Only after the document is scanned may a subsequent document may be placed on the ADF or flatbed and scanned. The subsequent scan is part of a second, separate scan job. Additionally, conventional scanners only permit a user to establish settings for an entire scan, so that a user cannot alter settings during the middle of a scan job.

Accordingly, there is a need for a scanning device and method which allows for the creation of a single scan job using multiple documents, and which will allow a user to modify scan settings during the middle of a scan job.

### BRIEF SUMMARY OF THE INVENTION

According to one embodiment of the invention, there is disclosed a method of executing a scan job. The method includes scanning a first document, in response to a first user request, to generate a first portion of a scan job, and scanning a second document, in response to a second user request, to generate a second portion of the scan job. The method also includes automatically forming an output document corresponding to the scan job, where the output document includes a combination of the first portion and second portion.

According to an aspect of the invention, the method further includes displaying a preview of at least one of the first or second portions of the scan job, prior to automatically forming the output document. According to another aspect of the invention, the method may also include receiving an input from the user indicating that the scan job is complete, prior to automatically forming the output document. According to yet another aspect of the invention, the method may include altering at least one scan setting, subsequent to the scanning of the first document and prior to the scanning of the second document.

According to another aspect, the at least one scan setting may alter page orientation, page size, output page size, scale, duplex, darkness, resolution or bit depth. Additionally, the first and second documents may be scanned using an automatic document feeder. The output document may also be stored in digital form.

According to another embodiment of the invention, there is disclosed a device for generating a document. The device includes a scanner module operative to receive and scan a first document as part of a scan job. receive and scan a second document as part of the same scan job, and generate an output document including the first document and second document. The device also includes a graphical user interface, in communication with the scanner module, which instructs the scanner module to scan the first document in response to a first instruction from a user, and instructs the scanner module to scan the second document in response to a second instruction from the user. The device further includes a memory capable of receiving the output document and storing the output document in digital form.

According to one aspect of the invention, the scanner module includes at least one scanner operative to scan documents via an automatic document feeder or a flatbed. According to another aspect of the invention, the scanner module may be operative to scan the first document and second document via the automatic document feeder. Furthermore, the graphical user interface may be further operable to display a preview of at least a portion of the scanned first document or scanned second document.

According to yet another aspect of the invention, the scanner module is operable to alter at least one scan setting for the scanning of the second document, based on an instruction input by the user via the graphical user interface. The at least one scan setting may be page orientation, page size, output page size, scale, duplex, darkness, resolution or bit depth.

According to yet another embodiment of the invention, there is disclosed a method of executing a custom scan job. The method includes receiving, at a scanning device, a user request to scan a first document as part of a scan job, and iteratively performing at the scanning device, until the receipt of a request from the user to complete the scan job, the steps of: requesting whether the user elects to scan a subsequent document as part of the scan job, and, in response to an affirmative response from the user, scanning the subsequent document as part of the scan job. The method also includes the step of generating an output document corresponding to the one or more documents forming the scan job.

According to an aspect of the invention, the method further includes the step of storing the output document in digital form. The method may also include displaying a preview of at least a portion of the first document or second document, prior to generating the output document. According to another aspect of the invention, the generation of the output document occurs automatically upon the receipt of the request from the user to complete the scan job. According to yet another aspect of the invention, the method further includes altering at least one scan setting of the scanning device, subsequent to the scanning of the first document. The at least one scan setting may be page orientation, page size, output page size, scale, duplex, darkness, resolution or bit depth. Further, the method may include the step, performed subsequent to the step of scanning the subsequent document as part of the scan job in response to an affirmative response from the user, of receiving an instruction from the user to discard or accept the scanned subsequent document.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a multi-function module, according to an embodiment of the present invention.

FIG. 2 shows a block diagram flow chart illustrating a method of scanning in accordance with an embodiment of the present invention.

FIG. 3 shows a custom scan GUI, according to an illustrative embodiment of the present invention.

FIG. 4 shows a custom next scan GUI, according to an illustrative embodiment of the present invention.

FIG. 5 shows a copy settings GUI, according to an illustrative embodiment of the present invention.

FIG. 6 shows an advanced duplex GUI, according to an illustrative embodiment of the present invention.

FIG. 7 shows a fax settings GUI, according to an illustrative embodiment of the present invention.

FIG. 8 shows an email settings GUI, according to an illustrative embodiment of the present invention.

FIG. 9 shows a scan preview GUI, according to an illustrative embodiment of the present invention

FIG. 10 shows a preview acceptance GUI, according to an illustrative embodiment of the present invention.

FIG. 11 shows a continue scanning GUI, according to an illustrative embodiment of the present invention.

FIG. 12 shows a preview/next scan GUI, according to an illustrative embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

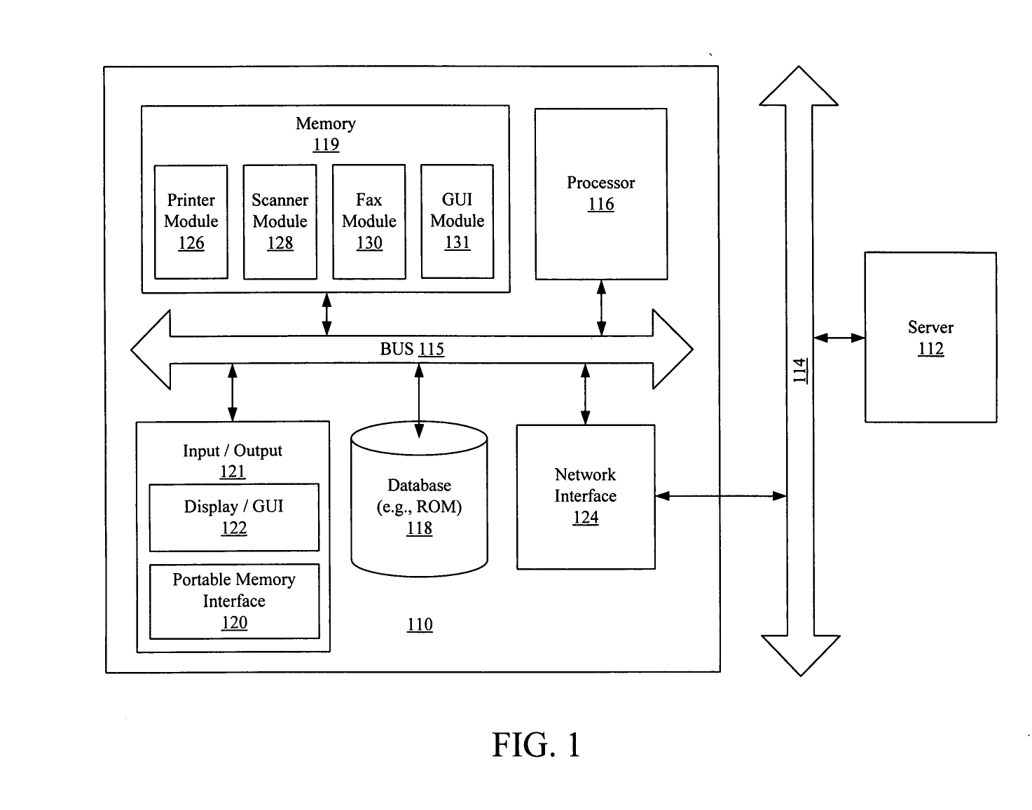

FIG. 1 shows a multi-function module 110, according to an embodiment of the present invention. The multi-function module 110 may represent a multi-function device, such as a printer/scanner/fax/copier, as is known in the art, or the control logic and/or control components within a multi-function device. The multi-function module 110 generally includes a processor 116, memory 119, input/output 121, database 118, and network interface 124, each of which may communicate via a bus 115. As shown in the embodiment of FIG. 1, the memory 119 can include a printer module 126, scanner module 128, fax module 130, and graphical user interface (GUI) module 31. The printer module 26, scanner module 28, and fax module 30 control the printing, scanning and fax functions, respectively, of the multi-function module 110. Additionally, the GUI module 131 controls the display of information on a display/GUI 122, which may be an input/output 121 device of the multi-function module 110.

It will be appreciated that the components described herein with respect to FIG. 1 may include computer-executable software running in conjunction with computer hardware. For instance, as illustrated in FIG. 1, and as described in detail below, the printer module 126, scanner module 128, fax module 130, and graphical user interface (GUI) module 131 may include computer executable programs (i.e., software) that may be stored within the memory 119 and executed by the processor 116 to effect the functions described in detail herein. According to an embodiment of the present invention, the processor 116 may execute computer executable programs with the aid of an operating system (not illustrated). According to other embodiments, one or more of the components illustrated in FIG. 1 may include hardware, such that the functions described herein are performed by hardware components. For instance, the processor 116, printer module 126, scanner module 128, fax module 130, and/or GUI module 131 may be implemented by an application-specific integrated circuit (ASIC), or the like, as is known in the art. Thus, it will be appreciated that the multi-function module 110 may be implemented in an entirely hardware embodiment, an embodiment combining software and hardware, or an embodiment comprised entirely of hardware.

As shown in FIG. 1, the multi-function module 110 is operatively coupled to a network 114, such as a LAN, WAN, or the like, via a network interface 124. The connection of the multi-function module 110 to the network 14 enables the multi-function module 110 to communicate with remote computing devices, such as one or more computers. According to an embodiment of the present invention, the multi-function module 110 may communicate with a server 112 via the network 114. The server 112 may be, for instance, a document server 112 that works in concert with the multi-function module 110 for performing special functions on electronic documents that may be handled by the multi-function module 110. For example, the multi-function module 10 can work in concert with the server 112 for emailing electronic documents scanned by the multi-function module 110 to a desired electronic address accessible via the network 14. Thus, the network 114 may represent a LAN that is in communication with a WAN, such as the Internet. The server 112 may also include specialized functions for setting up and controlling the operations of the multi-function module 110. It should also be apparent to those of ordinary skill that it is within the scope of the invention that the server 112 and multi-function module 110 may be combined into a single unit operatively coupled to the network 114.

Referring again to the multi-function module 110, the multi-function module 110 includes a database 118 that is operable to store documents, print jobs, and the like, that are created by the module 110 and/or received via the network 114 and the network interface 124. For instance, the database 118 may store print jobs received by the module 110 from computers in communication with the module 110 via the network 114, and store documents scanned by the module 110 with the aid of the scanner module 128, as described in detail below. The database 118 may include ROM, RAM, optical media, or other storage, as are well known in the art. According to one aspect of the invention, the database 118 may also store documents, print jobs, and the like, that are uploaded from a portable memory device via a portable memory interface 120.

According to an embodiment, the portable memory interface 120 may permit the module 110 to read/write (R/W) from a disk drive, R/W CD drive, flash media, USB device, or the like that is in communication with the module 110. The portable memory R/W device 120 may permit the multi-function module 110 to receive data from a local device and/or to write data to a local device. For instance, the module 110 may receive a .PDF document from a flash media inserted into an input/output port (not illustrated).

According to one aspect of the invention, the portable memory R/W device 120 may also be a read-only device, such as read-only CD drive.

Referring again to the printer module 126, scanner module 128, fax module 130, and GUI module 131, it will be appreciated that each are in communication with and coupled to the processor 116 via the bus 115. The printer module 126 includes, for example, the necessary hardware and/or software that allow the multi-function module 110 to print documents, including those submitted to the multi-function module 110 via a network 114 and a network interface 124, and those stored local to module 110. The fax module 130, may include, for example, the necessary hardware and/or code for faxing electronic documents over a telephone line (not illustrated) or the like. The fax module 130 may also have an internal scanning device for scanning tangible documents or may work with the scanning module 128 for scanning tangible documents and faxing documents over a telephone line. Additionally, the scanner module 128 may include, for example, the necessary hardware and/or software for scanning tangible documents on the multi-function module 110 and storing the scanned electronic documents in the database 118 or in a memory device 118, 120.

It will be appreciated that the printer module 126 and fax module 130 can include any suitable electronic and mechanical elements that together effect printing and faxing functions, respectively, of the type that conventionally occur in commercially available multifunction machines. Such elements are well-understood by persons skilled in the art to which the invention relates. Therefore, details of the printer module 126 and fax module 130, including the mechanical and other details of the manner in which they are constructed and communicate with one another and other elements to perform conventional printing and faxing functions are not described in further detail herein.

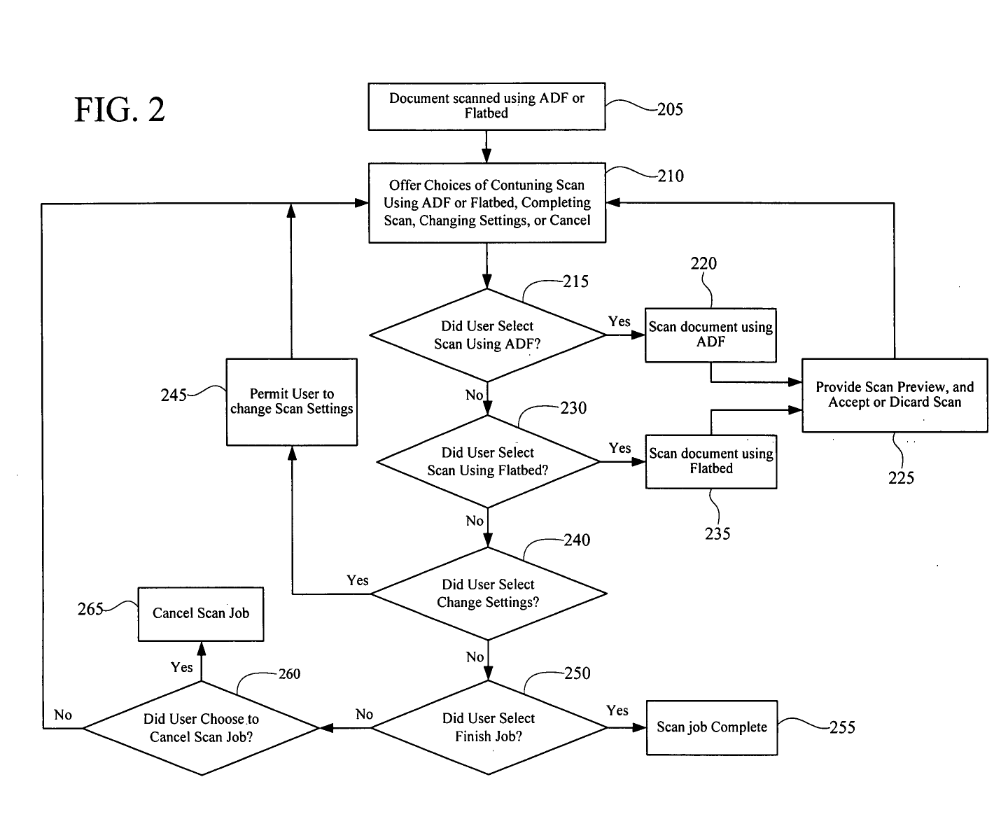

The conventional functions of the scanner module 128 are also known to those of ordinary skill in the art. However, the scanner module 128 also includes numerous features that are described in detail herein with respect to FIGS. 2-12, which permit a user of the multi-function module 110 to customize a particular scanning work flow. In particular, as described in detail below, the scanner module 128 permits a user to select more than one input source for a scan job, such that the user can execute a single scan job with documents located in a flatbed scanner and/or documents in the ADF and/or with documents stored by the module 110.

Scanning features enabled by the scanning module 128 are presented to a user via the display of information on the display/GUI 122. According to an embodiment of the invention, the display/GUI 122 may include an icon-based touch-screen (or similar) interface. It will be appreciated by those of ordinary skill in the art that the display/GUI 122 may include any type of moveable-cursor-based interface, which would typically necessitate the use of a cursor-control device such as a mouse, a roller ball, or any similar cursor-control devices known by those of ordinary skill. According to one aspect of the invention, the GUI module 131 includes GUI software that operates in accordance with conventional windowing GUI paradigms.

It will also be appreciated that the multi-function module 112 illustrated in FIG. 1 is according to an illustrative embodiment of the present invention. Therefore, one or more of the multi-function module 110 components described herein may be combined and/or placed external to the module 110, including remote from the module 110. Additionally, although described herein as a multi-function module, one or more of the components may be optional or unnecessary. For instance, the multi-function module 110 may represent a device that does not include a fax function, so that the multi-function module 110 may not include a fax module. Furthermore, although described herein as a multi-function module 110, according to an embodiment of the invention, the multi-function module 110 may alternatively have only a single or dedicated function, such as a scanning function requiring only the scanner module 128. Other embodiments of the multi-function module 110 are possible. For instance, although the printer module 126, scanner module 128, fax module 130, and GUI module 131 are illustrated as being stored in memory 119, they may be stored in the database 118 or external to the multi-function module 110 and fetched into memory 119 on an as-needed basis. Other software elements of the types conventionally included in personal computers, such as an operating system and communications software, are also included but not shown for purposes of clarity.

FIG. 2 shows a block diagram flow chart illustrating a method of scanning in accordance with an embodiment of the present invention. The scanning and GUI functions described with respect to the block diagram flow chart of FIG. 2 may be implemented by the scanner module 128 working in tandem with the GUI module 131, where the scanner module 128 executes the functions described herein and the GUI module 131 provides the user interfaces to receive user input upon which the scanner module 128 may execute. According to another embodiment, all of the scanning and GUI functions may be implemented by the scanner module 128.

As shown in FIG. 2, the method begins with a user scanning a document using either an ADF or a flatbed (block 205), as are known in the art. As described above, the scanner module 128 can include any suitable electronic and mechanical elements that together effect the scanning function is common in scanning or multifunction machines. According to one aspect of the invention, the scanner module 128 and/or multi-function module 110 may include an ADF and/or flatbed to effect the scanning of the document. After a document is scanned using an ADF or flatbed (block 205), the user may be presented with a GUI requesting input from the user. Specifically, the GUI will query whether the user wishes to: continue the scan using the ADF, continue the scan using the flatbed, complete the scan, change scan settings, and/or cancel the scan (block 210). If the user wishes to continue the scan using the ADF, the user selects the option using the GUI (block 215), and the scan continues using the ADF (block 220). The user may alternatively elect to continue the scan using the flatbed by selecting that option using the GUI (block 230), and the scan will continue using the flatbed (block 235). It will be appreciated that in this manner, a first document may be scanned using the ADF or flatbed (block 205), and a subsequent document may be scanned using the ADF (block 220) or flatbed (block 235), where both documents are part of the same scan job. As an illustrative and non-limiting example, using this process a user may generate a single output document, for instance, a PDF, from multiple documents scanned from either the ADF and/or flatbed.

After each scan the user may optionally be presented with a preview page via the display/GUI that illustrates one or more pages of the output document generated by the scanning process (block 225). For instance, a user may be presented with a preview page illustrating scanned pages from the first and subsequent documents so that the user can determine whether the scan accurately represents a document the user wishes to generate. After the preview page is displayed, the user may be presented with the option of accepting or discarding one or more of the scans from the scan job, such as the last scan performed (block 225). After accepting or discarding the scans, the user may be offered the options to continue the scan using the ADF, continue the scan using the flatbed, complete the scan, change scan settings, and/or cancel the scan (block 210).

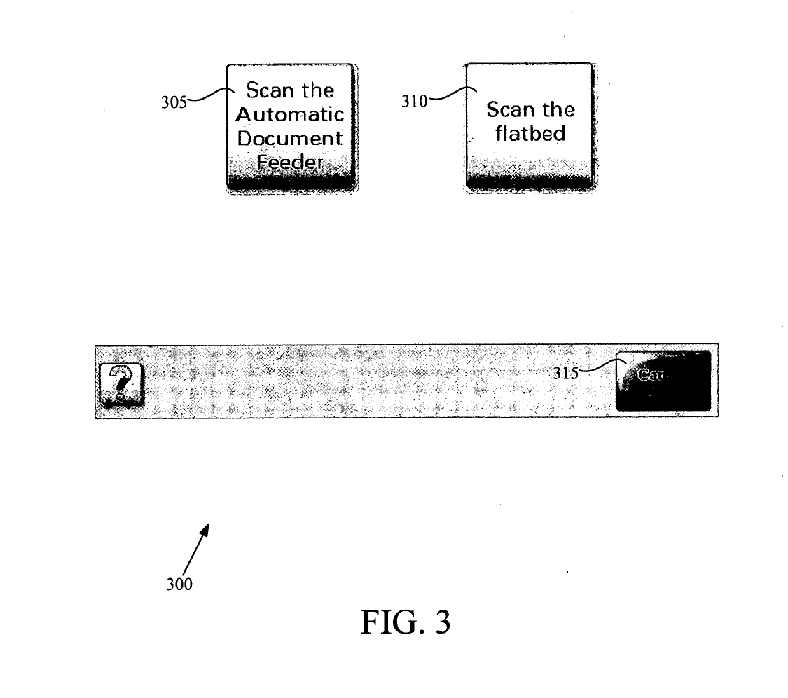

Referring once again to the options presented to the user (block 210) after the first document is scanned (block 205), the user may choose to change scan settings (blocks 240, 245) for one or more upcoming scans by selecting that option using the GUI. Using options presented by the GUI, the user may, among other settings, change the page orientation, page size, scale an image, add content, set duplex settings, change the darkness of an image, and the like. These settings are described in detail with reference to FIGS. 3-12. Thus, a scan of multiple documents may be customized on a document by document basis, during the scanning of the documents. Once the user changes scan settings, the settings may be used as default settings for the remainder of the scan job. Alternatively, the settings may be used only to define the settings for the next scan. After the settings are established (or if the user chooses not to make any changes to the settings), the user will be offered the options to continue the scan using the ADF, continue the scan using the flatbed, complete the scan, change scan settings, and/or cancel the scan (block 210).

Once the user has completed scanning one or more documents using the process described above the user may choose to finish the scan job by selecting that option using the GUI (blocks 250, 255). When this occurs, an output document corresponding to the scan job is generated. According to an aspect of the invention, the scan job is saved in the database 118. According to another aspect of the invention, the scan job may also or alternatively be stored by the server 112. As is well known in the art, the output document may be stored in a directory, and a print out of the location of the output document file may be provided to the user, such as via a print out, display, email, or the like. Once the output document is generated by the multi-function module 110, the user may then perform a number of functions using the output document, such as printing, emailing, faxing, or storing it, as is well known in the art. As illustrated in FIG. 2, the user is also offered the option to cancel the scan job (blocks 260, 265), such that the entire job is cancelled and the user is returned to a welcome screen or scan screen of the GUI. Next, the scanning functions according to an embodiment of the invention will next be described in detail with reference to FIGS. 3-12, which illustrate GUIs presented to a user to permit the generation of a custom scan job.

FIG. 3 shows a custom scan GUI 300 illustrating the display of scanning options on the display/GUI 22. This custom scan GUI 300 may be presented to a user after the user selects or activates scanning as a desired function of one of several basic functions, such as from a welcome screen (not shown) provided on the display/GUI 22. As illustrated in FIG. 3, via selectable icons 305, 310, the user is offered the options of performing a scan of a document placed in the Automatic Document Feeder (ADF), or alternatively, performing a scan of a document in the flatbed. According to one aspect of the invention, the options are offered via icons 305, 310 that may be selected by touch, where the display/GUI 22 is a touch screen display. Alternatively, the options may require the use of a cursor, one or more softkeys, or the like, as are known in the art. After the user executes a scan using the flatbed or ADF by selecting one of the icons 305, 310, the user is presented with a custom next scan GUI 400.

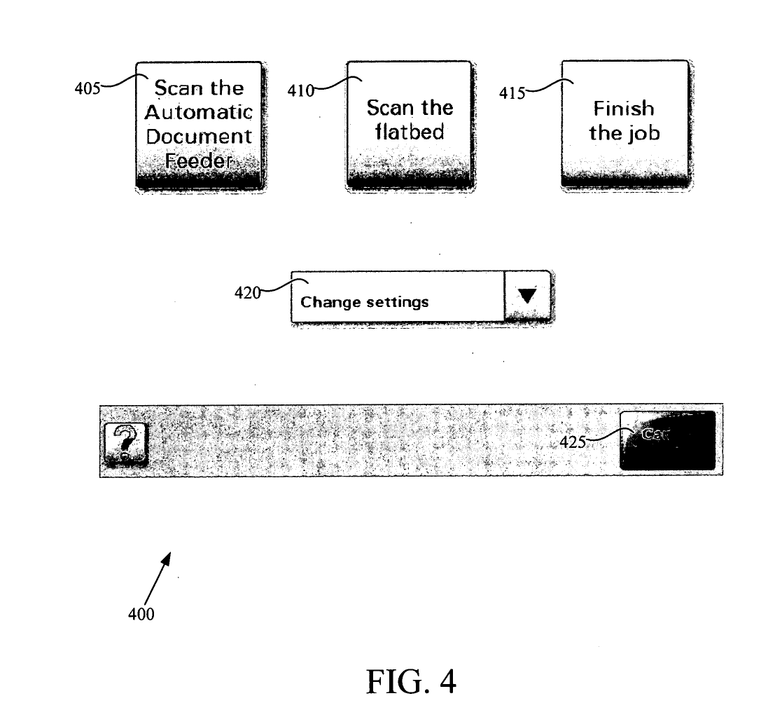

FIG. 4 shows a custom next scan GUI 400 that is provided to a user immediately after the initial scan of a document via the flatbed or ADF. As shown in FIG. 4, after the initial scan is completed, the user is presented with the following user-selectable options: continuing the scan using the ADF (icon 405), continuing the scan using the flatbed (icon 410), finishing the scan job (icon 415), or changing the scan settings (change settings pull down selection 420). Additionally, a cancel job option (icon 425) may be selected by the user to cancel the scan. If the user elects to continue the scan from the ADF (icon 405) or the flatbed (icon 410), the scan job will continue with the scanning of the additional document in the selected location. As described in detail below, subsequent to the scan, the user may be presented with one or more scan preview pages to accept or reject the scan, followed by options to continue the scan using the ADF or flatbed, finishing the scan job, changing the scan settings, or canceling the scan.

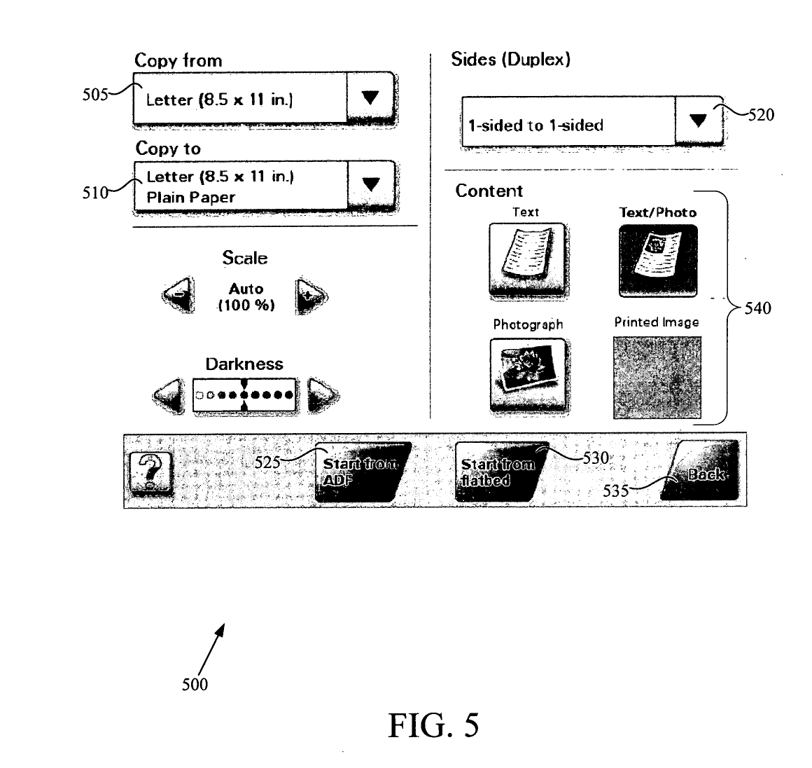

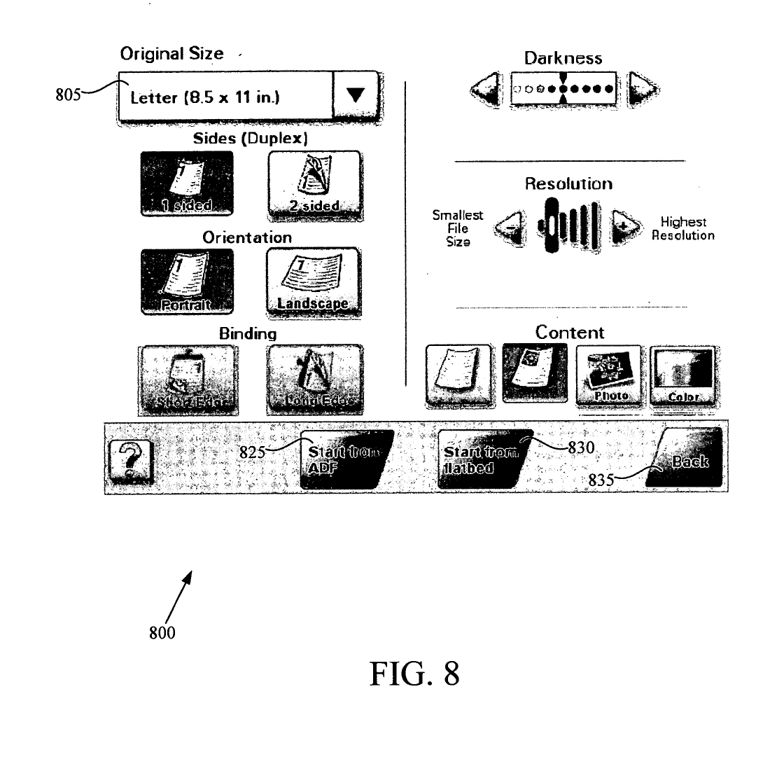

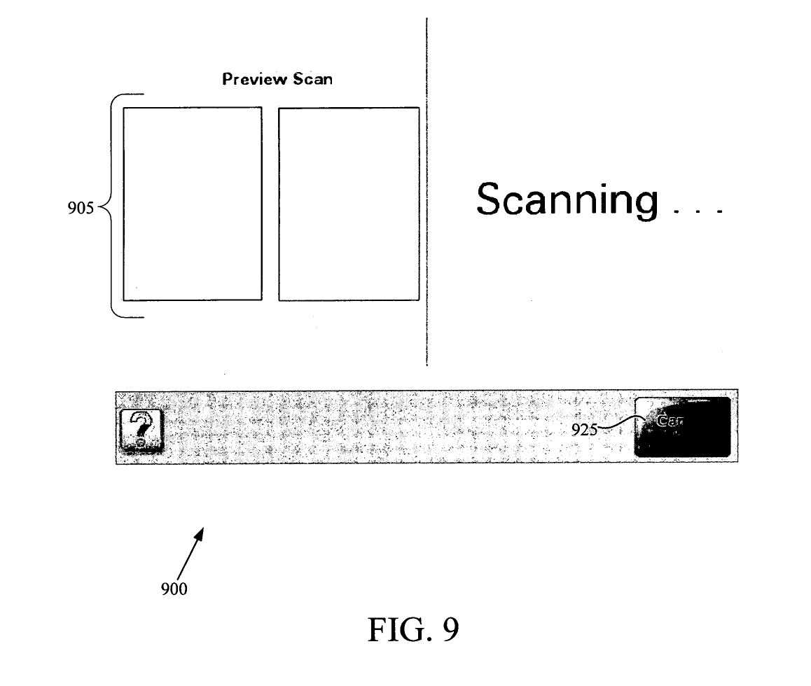

According to an embodiment of the present invention, from the custom next scan GUI 400, a user may change the setting between sets of scans using the change settings pull down selection 420. Among other settings, this may enable a user to alter page orientation, page size, output page size, scale, content (addition or removal), duplex settings, image darkness, resolution and bit depth, and the like. Thus, a scan of multiple documents may be customized on a document by document basis, during the creation of a scan job. According to one aspect of the invention, the options from the change settings pull down selection 420 can include Copy, Fax, and Email, which allows the user to alter the scan settings, respectively, based on the purpose of the scan. An illustrative copy settings GUI 500 that may be accessed via the change settings pull down selection 420 is illustrated in FIG. 5. Additionally, an illustrative fax settings GUI 800 is shown in FIG. 8, and an illustrative email settings GUI 900 is shown in FIG. 9.

FIG. 5 shows a copy settings GUI 500, according to an illustrative embodiment of the present invention. As illustrated in FIG. 5, the original and output sizes may be altered by a copy pulldown selection 505 and output pulldown selection 510, respectively. The copy pulldown selection 505 permits the user to identify the size of the document to be scanned, and the output pulldown selection 510 permits the user to define the output size of the current scan. Altering these selections 505, 510 may impact additional options made available to the user on the copy settings GUI 500 and other GUIs so that incompatible items and/or settings are prevented from being set at the same time.

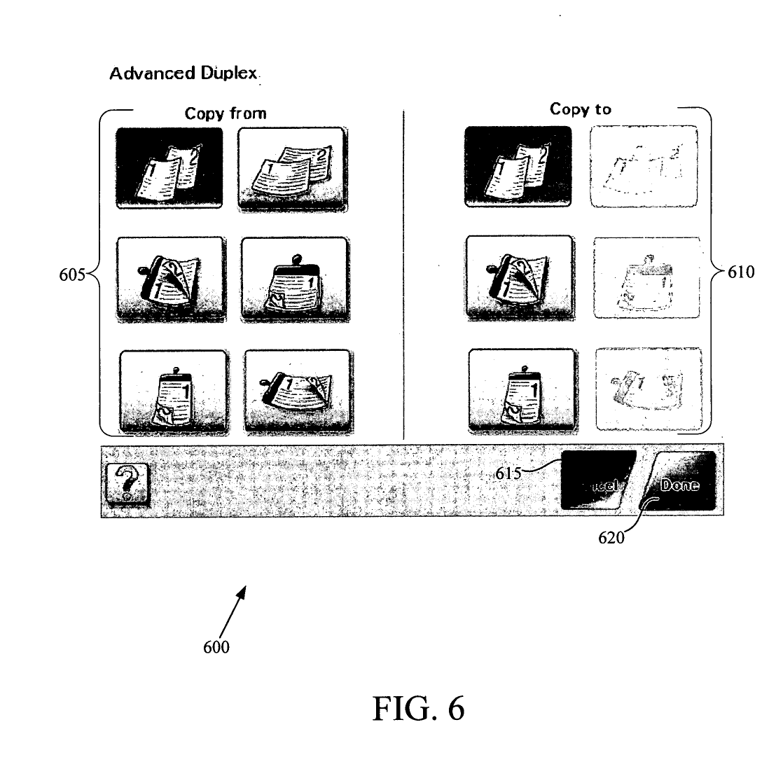

The copy settings GUI 500 also include a duplex button 520 to enable the user to change the duplex settings, as known in the art. According to one aspect, upon selecting the duplex button 520, the user will be presented with an advanced duplex GUI 600 illustrated in FIG. 6. The advanced duplex GUI 600 may be, according to an aspect of the invention, similar or identical to the advanced duplex screen the user would encounter if the user were to select to change duplex settings during a copy operation. The advanced duplex GUI 600 may include user-selectable copy from icons 605 and copy to icons 610 that graphically illustrate the available duplex options available. One or more icons may be grayed out or not presented to the user, based in part on the original and output sizes selected by the user using the copy settings GUI 500. After the duplex settings are selected by the user using the copy from icons 605 and copy to icons 610, the user may return to the copy settings GUI 500 by selecting the back button 620. To return to the copy settings GUI 500 without making any changes to the duplex settings, the user may select the cancel button 615.

Referring again to FIG. 5, the copy settings GUI 500 may also include one or more content buttons 540 that enable a user to add content to a scanned document, such as by adding text and photo, photo, or the like, as is known in the art. After the user had completed making changes via the copy settings GUI 500, the user may select to begin the scan from the ADF by selecting a start scan from ADF icon 525, or may select to begin the scan from the flatbed by selecting a start scan from flatbed icon 530. When one of those icons 525, 530 is selected, the scan may begin from the requested location, with the settings established by the user. After the scan is completed, the user will return to the custom next scan GUI 400. Additionally, the user may return to the custom next scan GUI 400 by selecting a back button 535. Using the copy settings GUI 500 allows a user to specify settings for each document, so that an output document may be generated from multiple scans, with custom settings for each scanned document within the output document. Thus, all of the items in the scan work flow may become part of the same job, with the output document including multiple collated items in scan order as specified by the user during the scanning process.

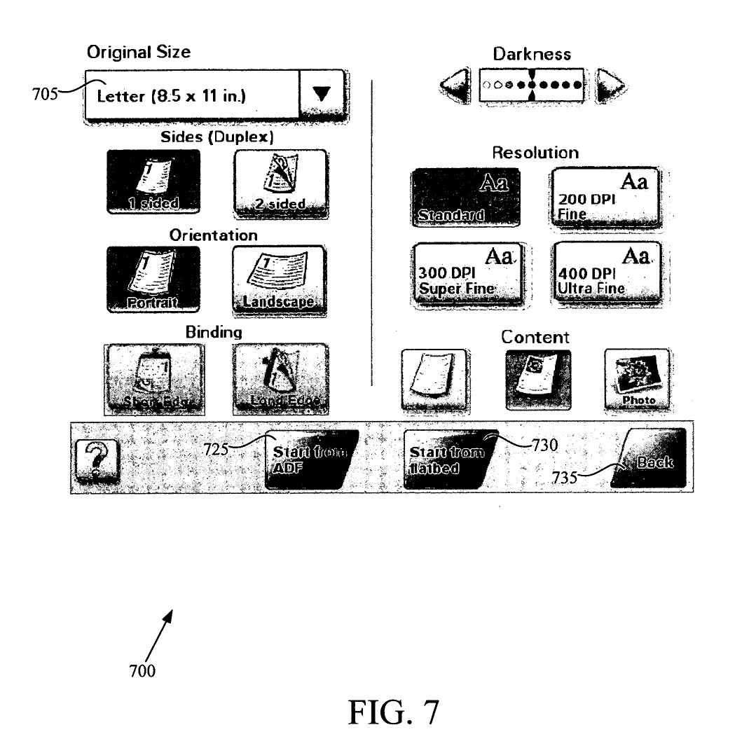

An embodiment of the fax settings GUI 700 is shown in FIG. 7. The fax settings GUI 700 may be accessed from the change settings pulldown selection 420 on the custom next scan GUI 400, as described above. In particular, the fax settings GUI 700 permits the user to alter the settings for a scanned document the user may wish to fax using the multi-function module 110. The fax settings GUI 700 includes an original size selection 705 that permits the user to identify the size of the document to be faxed. Other user-selectable options on the fax settings GUI 700 may include duplex, orientation, darkness, resolution, and content. After the user has completed making changes via the fax settings GUI 700, the user may select to begin the scan from the ADF by selecting a start scan from ADF icon 725, or may select to begin the scan from the flatbed by selecting start scan from flatbed icon 730. When one of those icons 725, 730 is selected, the scan may begin from the requested location, with the settings established by the user. After the scan is completed, the user will return to the custom next scan GUI 400. Additionally, the user may return to the custom next scan GUI 400 by selecting a back button 735.

FIG. 8 shows an email settings GUI 800, according to an embodiment of the present invention. The email settings GUI 800 is similar to the fax settings GUI 700, and like the fax settings GUI 700, it may be accessed by a user from the change settings pulldown selection 420 on the custom next scan GUI 400, as described above. In particular, the email settings GUI 800 permits the user to alter the settings for a scanned document the user may wish to email using the multi-function module 110. The email settings GUI 800 include an original size selection 805 that permits the user to identify the size of the document to be emailed. Other user-selectable options on the email settings GUI 800 may include duplex, orientation, darkness, resolution, and content. After the user has completed making changes via the email settings GUI 800, the user may select to begin the scan from the ADF by selecting a start scan from ADF icon 825, or may select to begin the scan from the flatbed by selecting start scan from flatbed icon 830. When one of those icons 825, 830 is selected, the scan may begin from the requested location, with the settings established by the user. After the scan is completed, the user will return to the custom next scan GUI 400. Additionally, the user may return to the custom next scan GUI 400 by selecting a back button 835.

According to one embodiment of the invention, scan jobs may include scan preview GUIs that permit a user to view the results of each scan that makes up a scan job. The GUIs may also incorporate one or more features of the custom next scan GUI 400 described with respect to FIG. 4, such as permitting a user to switch scan sources and change scan settings. According to another aspect of the invention, the scan preview GUIs may permit a user to discard one or more parts of a scan job.

FIG. 9 shows an example of a scan preview GUI 900, according to an illustrative embodiment of the present invention, that may be displayed to the user during the scanning process from the ADF or flatbed. The scan preview GUI 900 includes a preview scan window 905 that show the results one or more pages of the scan, or portions thereof, as it occurs in real time, or alternatively, immediately after the scan is complete. Like other GUIs described herein, the scan preview GUI 900 may include a cancel job button 925 that permits a user to cancel the scan job. Pressing the cancel job button may cancel the current scan and return the user to the custom next scan GUI 400.

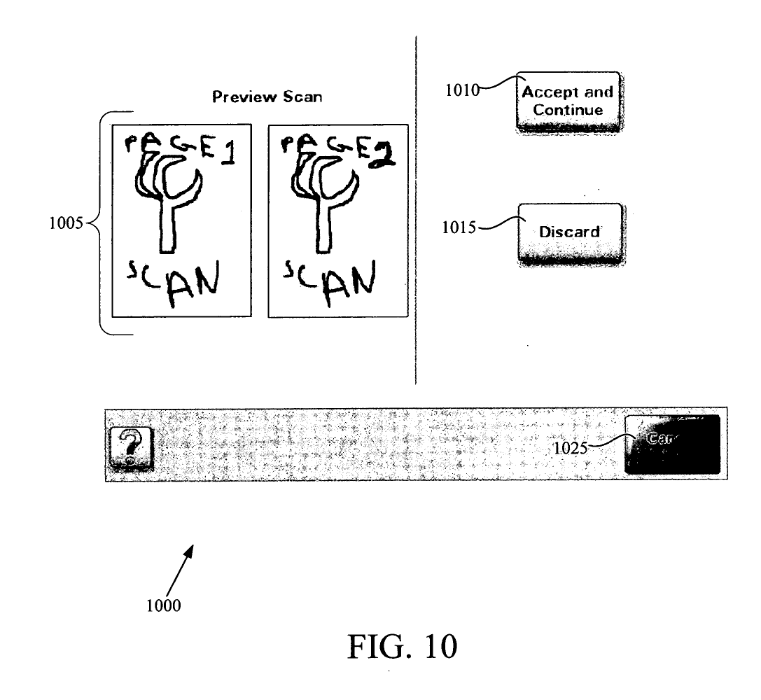

According to one aspect of the invention, the preview scan window 905 shows the results of the first two pages that are scanned to allow the user to confirm that the scan of a document is acceptable, including, for instance, the scan settings. FIG. 10 shows a preview acceptance GUI 1000 according to an embodiment of the invention, which shows the results of the first two pages scanned of an illustrative, multi-page document, where the preview scan window 1005 displays the first two pages. When the scan of the first page or two are complete, the user may be presented with an accept and continue button 1010 or a discard button 1015. Discarding the scan may return the user to the custom next scan GUI 400.

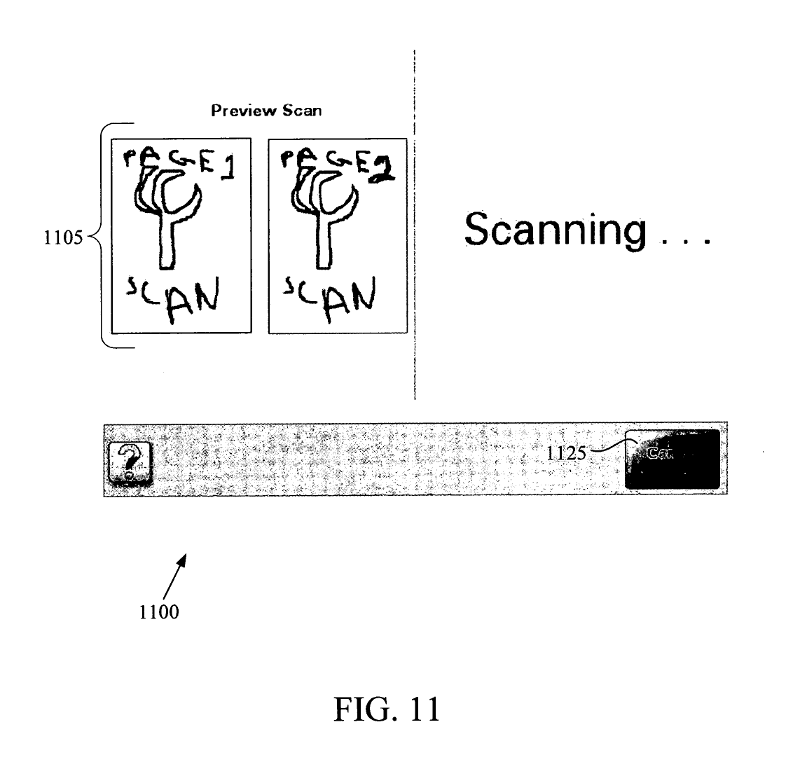

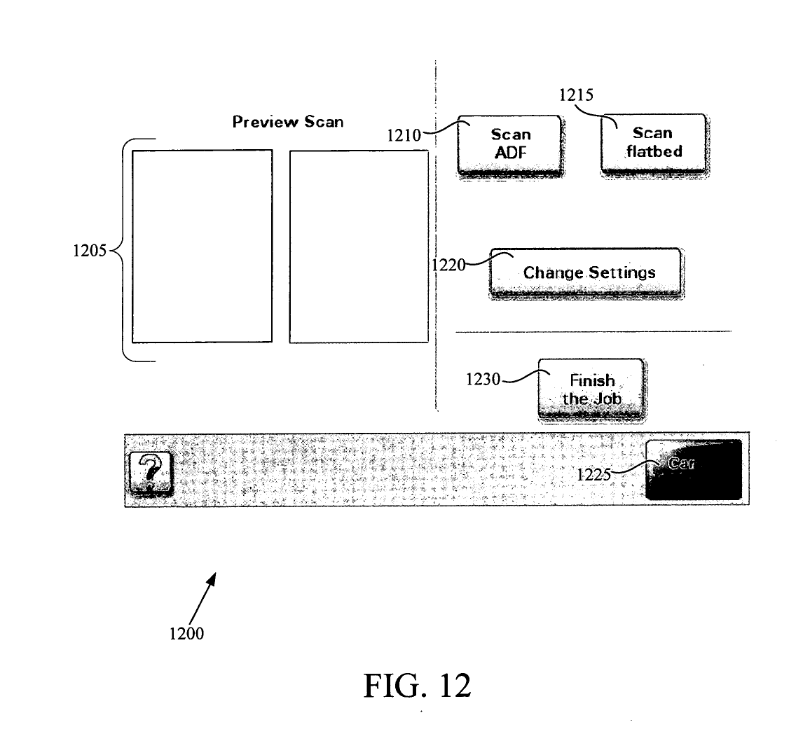

On the other hand, if the continue button 1010 is selected for a document in the ADF, and there is additional paper in the ADF, the image or images may stay in the preview Scan 1105 window while the ‘Scanning’ text returns in the right side of the view, as shown in the continue scanning GUI 1100 of FIG. 11. If no more paper is in the ADF, or if the flatbed was used, the scan is complete and the user may be presented with the preview/next scan GUI 1200 shown in FIG. 12, according to an illustrative embodiment of the present invention. Alternatively, the user may be returned to the custom next scan GUI 400. The preview/next scan GUI 1200 may include the preview scan window showing one or more pages of the last document scanned. Additionally, like the custom next scan GUI 400, the preview/next scan GUI 1200 may offer the user to continue the scan using the ADF or flatbed, via a scan ADF button 1210 or a scan flatbed button 1215, to change settings via a change settings button 1220, to finish the scan job via a finish the job button 1230, or to cancel the job via a cancel job button 1225.

With respect to FIGS. 9-12, it will be appreciated that where the flatbed is being used, the preview scan window may optionally only display one page, as only one page is scanned using the flatbed. Thus, the illustrative embodiments shown in FIGS. 9-12 may represent a scan using the ADF. According to another aspect of the invention, these options to accept and/or discard a scan may be offered to the user only after an entire document is scanned. Additionally, according to an aspect of the invention, one or more pages of a scanned document may be previewed in a preview scan window, such as through the use of one or more next/previous page buttons to permit the user to preview the entire scanned document. Furthermore, a user may alter the number of pages in the preview scan window, or the size of the preview scan window, using the change settings option.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of executing a scan job, comprising:
scanning a first document, in response to a first user request, to generate a first portion of a scan job;
scanning a second document, in response to a second user request, to generate a second portion of the scan job; and
automatically forming an output document corresponding to the scan job, wherein the output document comprises a combination of the first portion and second portion.

2. The method of claim 1, further comprising displaying a preview of at least one of the first or second portions of the scan job, prior to automatically forming the output document.

3. The method of claim 1, further comprising receiving an input from the user indicating that the scan job is complete, prior to automatically forming the output document.

4. The method of claim 1, further comprising altering at least one scan setting, subsequent to the scanning of the first document and prior to the scanning of the second document.

5. The method of claim 4, wherein the at least one scan setting is selected from the group of settings consisting of page orientation, page size, output page size, scale, duplex, darkness, resolution and bit depth.

6. The method of claim 1, wherein the first and second documents are scanned using an automatic document feeder.

7. The method of claim 1, further comprising storing the output document in digital form.

8. A device for generating a document, comprising:
a scanner module, the scanner module operative to:
receive and scan a first document as part of a scan job;
receive and scan a second document as part of the same scan job; and
generate an output document comprising the first document and second document;
a graphical user interface, in communication with the scanner module, which instructs the scanner module to scan the first document in response to a first instruction from a user, and instructs the scanner module to scan the second document in response to a second instruction from the user; and
a memory capable of receiving the output document and storing the output document in digital form.

9. The device of claim 8, wherein scanner module includes at least one scanner operative to scan documents via an automatic document feeder or a flatbed.

10. The device of claim 8, wherein the scanner module is operative to scan the first document and second document via the automatic document feeder.

11. The device of claim 8, wherein the graphical user interface is further operable to display a preview of at least a portion of the scanned first document or scanned second document.

12. The device of claim 8, wherein the scanner module is operable to alter at least one scan setting for the scanning of the second document, based on an instruction input by the user via the graphical user interface.

13. The device of claim 12, wherein the at least one scan setting is selected from the group of settings consisting of page orientation, page size, output page size, scale, duplex, darkness, resolution and bit depth.

14. A method of executing a custom scan job, comprising:
receiving, at a scanning device, a user request to scan a first document as part of a scan job; and
at the scanning device, until the receipt of a request from the user to complete the scan job, iteratively performing the steps of:
(a) requesting whether the user elects to scan a subsequent document as part of the scan job; and
(b) in response to an affirmative response from the user, scanning the subsequent document as part of the scan job; and
generating an output document corresponding to the one or more documents forming the scan job.

15. The method of claim 14, further comprising the step of storing the output document in digital form.

16. The method of claim 14, further comprising displaying a preview of at least a portion of the first document or second document, prior to generating the output document.

17. The method of claim 14, wherein the generation of the output document occurs automatically upon the receipt of the request from the user to complete the scan job.

18. The method of claim 14, further comprising altering at least one scan setting of the scanning device, subsequent to the scanning of the first document.

19. The method of claim 18, wherein the at least one scan setting is selected from the group of settings consisting of page orientation, page size, output page size, scale, duplex, darkness, resolution and bit depth.

20. The method of claim 14, further comprising the step, performed subsequent to the step of scanning the subsequent document as part of the scan job in response to an affirmative response from the user, of receiving an instruction from the user to discard or accept the scanned subsequent document.
